(19) United States
(12) Patent Application Publication
(10) Pub. No.: US 2017/0361262 A1
(43) Pub. Date: Dec. 21, 2017

(54) COMPACT AIR PURIFICATION APPARATUS

(71) Applicant: NANO WAVE CO., LTD., Hachioji-shi, Tokyo (JP)

(72) Inventor: Yuji IMAI, Hachioji-shi, Tokyo (JP)

(21) Appl. No.: 15/539,511

(22) PCT Filed: Nov. 25, 2015
(86) PCT No.: PCT/JP2015/083025

§ 371 Date: Jun. 23, 2017

(30) Foreign Application Priority Data
Dec. 25, 2014 (JP) 2014-262542

(51) Int. Cl. B01D 53/00; B01J 21/06; B01J 31/06; B01D 53/88; B01J 35/04; B01J 35/00

(52) U.S. Cl. CPC B01D 53/007; B01J 35/04; B01J 35/004; B01J 31/06; B01D 53/885; B01J 21/063; B01D 2255/802; B01D 2255/20707; B01D 2259/804

(57) ABSTRACT

A compact air purification apparatus which can improve an acetaldehyde removal performance and of which the size can be reduced is provided. A compact air purification apparatus using a photocatalyst includes a housing, a photocatalyst member that is disposed in the housing and contains titanium oxides, a light emitting unit that is disposed in the housing to irradiate the photocatalyst member with ultraviolet light and includes a plurality of LED elements, and a fan that circulates air inside the housing.

### TECHNICAL FIELD

The present invention relates to a compact air purification apparatus which uses a photocatalyst.

### BACKGROUND ART

A photocatalyst such as titanium oxides (TiO₂) is activated when irradiated with ultraviolet rays to effect a strong oxidation-reduction action and perform an action of effectively decompose contaminants, toxic compounds such as nitrogen oxides (NOₓ) or sulfur oxides (SOₓ), and the like. An apparatus in which an ultraviolet lamp is accommodated in a housing having an inlet opening and an outlet opening and a photocatalyst is disposed in an irradiation range of ultraviolet rays generated by the ultraviolet lamp is known as an example of a compact air purification apparatus which uses a photocatalyst (see Patent Literature 1).

### CITATION LIST

### Patent Literature

Patent Literature 1: Japanese Patent Application Publication No. 2003-220123

### SUMMARY OF INVENTION

### Technical Problem

However, there is a problem that it is difficult to obtain a sufficient acetaldehyde removal performance unless many fluorescent black light tubes are used when titanium oxides are excited. Moreover, since the fluorescent black light tubes are long, there is another problem that the size of the apparatus increases.

The present invention has been made in view of the above problems, and an object thereof is to provide a compact air purification apparatus which can improve an acetaldehyde removal performance and of which the size can be reduced.

### Solution to Problem

The present invention provides a compact air purification apparatus including a housing, a photocatalyst member that is disposed in the housing and contains titanium oxides, a light emitting unit that is disposed in the housing to irradiate the photocatalyst member with ultraviolet light and includes a plurality of LED elements, and a fan that circulates air inside the housing.

In the compact air purification apparatus, the light emitting unit preferably has a copper-based substrate on which the LED elements are mounted.

In the compact air purification apparatus the fan is preferably a sirocco fan.

In the compact air purification apparatus, a power supply unit of the light emitting unit is exposed in the housing.

In the compact air purification apparatus, the light emitting unit is preferably a halogen lamp-shaped light emitting device and preferably has a highly integrated structure.

### Advantageous Effects of Invention

According to the present invention, it is possible to improve an acetaldehyde removal performance.

### BRIEF DESCRIPTION OF DRAWINGS

FIG. 1 is a schematic cross-sectional explanatory view of a compact air purification apparatus, illustrating an embodiment of the present invention.

FIG. 2 is a plan view of a LED mounting substrate in which 13×4 LED elements are arranged.

FIG. 3 is a cross-sectional view of a portion of a mounting substrate in which LED elements are mounted on a Cu substrate.

FIG. 4 is a graph illustrating an acetaldehyde removal performance.

FIG. 5 is a schematic cross-sectional explanatory view of a compact air purification apparatus, illustrating a modification.

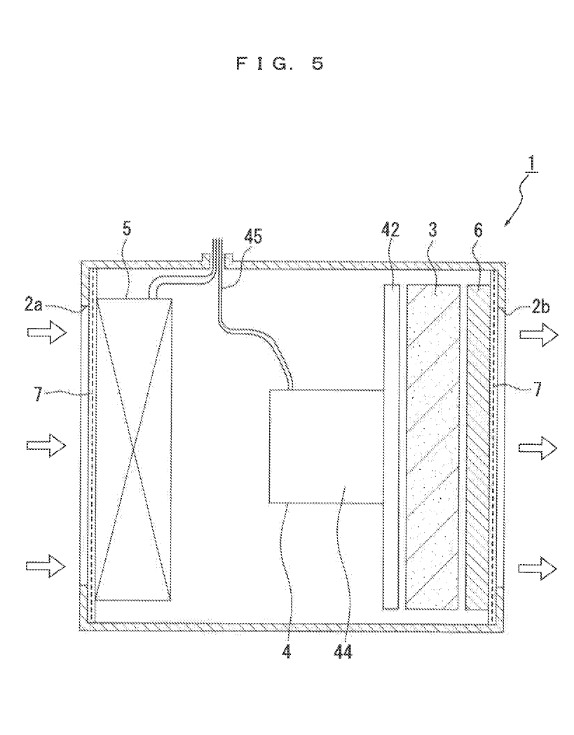

FIG. 6 is a graph illustrating an operation performance of LED elements, in which a horizontal axis indicates a forward current (mA) and a vertical axis indicates LED light output power (mW).

### DESCRIPTION OF EMBODIMENTS

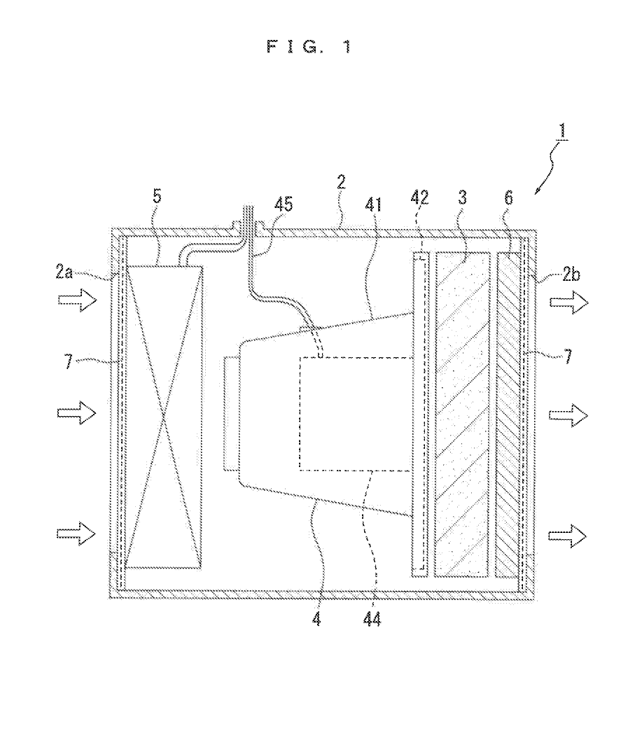

FIGS. 1 to 3 illustrate an embodiment of the present invention, and FIG. 1 is a schematic cross-sectional explanatory view of a compact air purification apparatus.

As illustrated in FIG. 1, a compact air purification apparatus 1 includes a rectangular parallelepiped housing 2, a ceramic foam disposed in the housing 2 and coated with titanium oxides (TiO₂), a light emitting device 4 disposed in the housing 2 to irradiate the ceramic foam 3 with ultraviolet light, a fan 5 that circulates air inside the housing 2, and a filter 6 disposed in the housing 2 to remove dust in the air.

The housing 2 is formed of aluminum, for example, and has an inlet opening 2a and an outlet opening 2b. In the present embodiment, the inlet opening 2a and the outlet opening 2b are formed in side surfaces that face each other. In the housing 2, the fan 5, the light emitting device 4, the ceramic foam 3, and the filter 6 are arranged in that order from the inlet opening 2a toward the outlet opening 2b.

The housing 2 has such dimensions that the length in an air flowing direction is 20 cm, the length in a horizontal direction orthogonal to the air flowing direction is 15 cm, and the length in a height direction is 15 cm. Here, the conventional fluorescent black light tubes are long, and it was necessary to set the size in the height direction of the conventional housing to be at least 20 cm or longer. Furthermore, no effect is obtained with one black light tube and practically a plurality of black light tubes is used. However, the size in the height direction of the housing can be reduced to 15 cm by using the light emitting device 4 having a plurality of LED elements 43. When the dimensions of the rectangular parallelepiped housing 2 can be set such that one side is 20 cm or smaller and the other two sides are 15 cm or smaller, this apparatus can be said to be a “compact” air purification apparatus.

The inlet opening 2a and the outlet opening 2b are covered with an insect screen 7 formed of an antibacterial material. Due to this, insects attracted by the light of the light emitting device 4 will not enter into the housing 2.

The ceramic foam 3 as a photocatalyst member is formed of alumina, for example, and a three-dimensional mesh structure is formed therein. The surface of the ceramic foam 3 is coated with particles of titanium oxides as a photocatalyst. Titanium oxides can be excited with light having a wavelength of 410 nm or smaller and purifies air near an excited portion.

During operation, the fan 5 delivers air inside the housing 2 from the inlet opening 2a toward the outlet opening 2b. The form of the fan 5 is arbitrary and may be a propeller fan or a sirocco fan. By using a sirocco fan as the fan 5, it is possible to effectively decrease the temperature of a housing 41 of the light emitting device 4 and to improve light output power of the LED elements 43 of the light emitting device 4. Moreover, the filter 6 is provided to block the outlet opening 2a in the housing 2.

The light emitting device 4 as the light emitting unit includes the housing 41, a power supply substrate 44 disposed inside the housing 41, a plurality of LED elements 43 mounted on a mounting substrate 42 above the housing, and a wiring 45 that connects an external power supply (not illustrated) for supplying direct-current electric power to the power supply substrate 44. The housing 41 is formed of ceramics, for example, and has an opening. The light emitting device 4 emits light of the respective LED elements 43 from the opening of the housing 41.

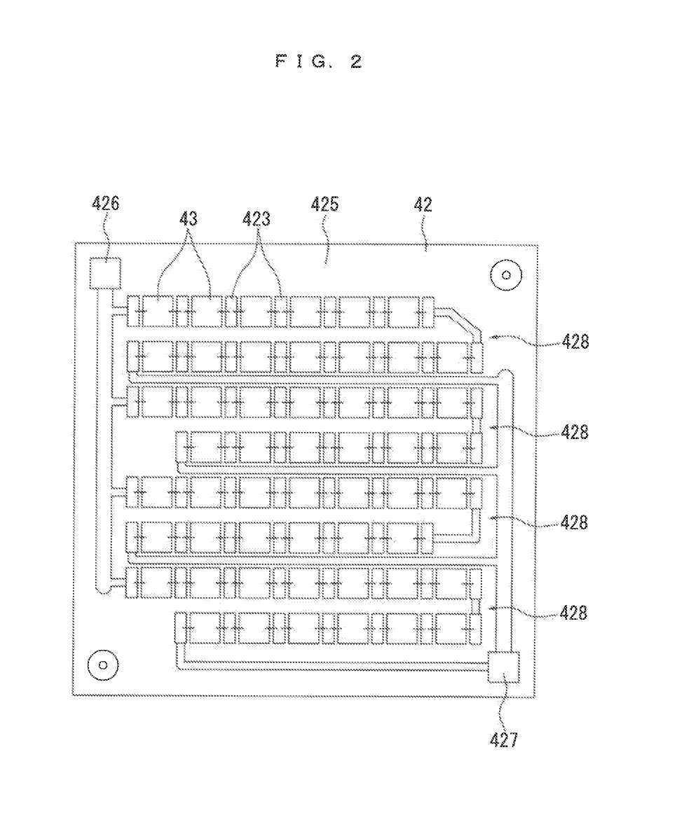

FIG. 2 is a plan view of a LED mounting substrate in which 13×4 LED elements are arranged.

As illustrated in FIG. 2, the LED mounting substrate 42 is formed in a square form, and the respective LED elements 43 are arranged in a vertical direction and a horizontal direction. A circuit pattern 423 includes a pair of anode electrode 426 and cathode electrode 427 and supplies electric power to the respective LED elements 43. In the present embodiment, four series connection portions 428 in which thirteen LED elements 43 are arranged are connected in parallel whereby fifty two LED elements 43 in total are used. The number of LED elements 43 used in the light emitting device 4 is preferably 50 or more.

Specifically, each LED element 43 has a dimension of 350 μm by 350 μm in a plan view and is mounted on the LED mounting substrate 42 with mounting accuracy of 20 μm to 200 μm. By mounting the LED elements with this mounting accuracy, a highly integrated structure of the LED elements 43 is realized. When a highly integrated structure of the LED elements 43 is realized, the shape of the housing 41 is arbitrary and a halogen lamp-shaped housing, for example, can be user device as the housing 41. In the present embodiment, the light output power of the light emitting device 4 is 600 mW or higher.

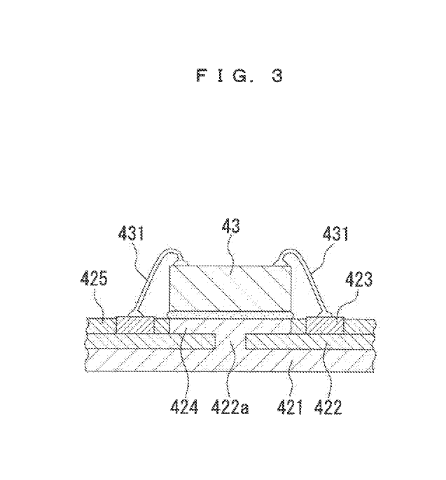

FIG. 3 is a cross-sectional view of a portion of a mounting substrate in which LED elements are mounted on a Cu substrate.

As illustrated in FIG. 3, the LED mounting substrate 42 includes a substrate body 421 formed of metal, an insulating layer 422 formed on an upper side of the substrate body 421 and formed of a resin, a circuit pattern 423 and a heat radiation pattern 424 formed on an upper side of the insulating layer 422 and formed of metal, and a white resist layer 425 as a surface layer formed on an upper side of the insulating layer 422 and formed of an insulating material. The substrate body 421 is formed of copper and is connected to the heat radiation pattern 424 through a heat radiating portion 422a that passes through the insulating layer 422 and is formed of metal. In the present embodiment, the heat radiating portion 422a and the heat radiation pattern 424 are also formed of copper. The insulating layer 422 is formed of a polyimide resin, an epoxy resin, a liquid crystal polymer, or the like and achieves insulation between the substrate body 421 and the circuit pattern 423 which have conductive properties. The circuit pattern 423 is formed of copper having a thin film of gold formed on a surface (an upper surface), for example, and is electrically connected to the respective LED elements 43 by wires 431. The white resist layer 425 is formed of an epoxy-based resin in which titanium oxide fillers are mixed, for example, and appears white.

Each LED element 43 has an InGaN-based light emission layer, for example, and emits ultraviolet light. A peak wavelength of each LED element 43 is preferable 400 nm or longer and 410 nm or shorter. In the present embodiment, the peak wavelength of each LED element 43 is 405 nm. In the present embodiment, the LED elements 43 are face-up-type elements and are electrically connected to the circuit pattern 20 by wires 60.

In the compact air purification apparatus 1 having such a configuration, when the fan 5 is operated in a state in which ultraviolet light is irradiated from the light emitting device 4 to the ceramic foam 3, air taken from the inlet opening 2a can be purified by the ceramic foam 3 and be discharged from the outlet opening 2b. Here, since a high-integration and high-output-power structure is realized as the light emitting device 4 using the LED elements 43 that emit ultraviolet light, it is possible to improve an acetaldehyde removal performance further than black light tubes which use fluorescent tubes.

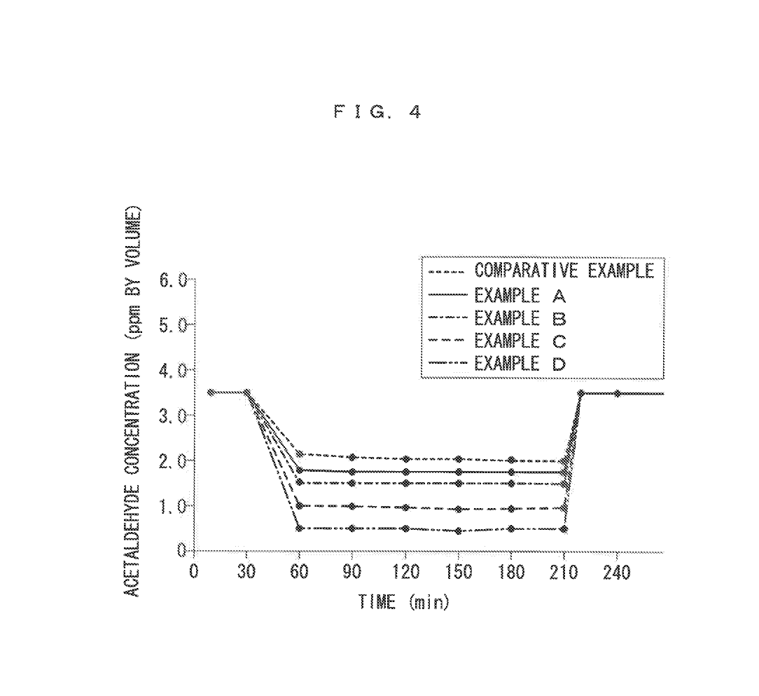

FIG. 4 is a graph illustrating an acetaldehyde removal performance in which the horizontal axis indicates time the vertical axis indicates an acetaldehyde concentration. When the acetaldehyde removal performance is examined, first, an example (hereinafter Comparative example) in which a fluorescent black light tube is used was compared with an example (hereinafter Example A) in which the mounting substrate 42 of the light emitting device 4 which uses the LED elements 43 is formed of aluminum. In Comparative example and Example A, a propeller fan was used as the fan. When data is acquired, irradiation of ultraviolet rays started after 30 minutes elapsed from the start of examination, and ended after 220 minutes elapsed from the start of examination. As illustrated in FIG. 4, in Example A, the acetaldehyde concentration decreased during irradiation of ultraviolet rays as compared to Comparative example. From this, it is understood that the acetaldehyde removal performance was improved since the LED elements 43 have a high-integration and high-output structure.

Next, Example A was compared with an example (hereinafter Example B) in which the mounting substrate 42 is formed of copper. In Example B, a propeller fan was used as the fan. As illustrated in FIG. 4, in Example B, the acetaldehyde concentration decreased during irradiation of ultraviolet rays as compared to Example A. From this, it is understood that the acetaldehyde removal performance was improved further since the mounting substrate 42 of the light emitting device 4 is formed as a copper-based substrate.

Next, Example B was compared with an example (hereinafter Example C) in which the fan 5 is a sirocco fan. In Example C, a copper-based substrate was used as the mounting substrate 42. As illustrated in FIG. 4, in Example C, the acetaldehyde concentration decreased during irradiation of ultraviolet rays as compared to Example B. From this, it is understood that the acetaldehyde removal performance was improved further since the fan 5 of the compact air purification apparatus 1 is a sirocco fan.

Next, Example C was compared with an example (hereinafter Example D) in which the housing 41 of the light emitting device 4 is removed and the power supply substrate 44 is open to the air. In Example D, a copper-based substrate was used as the mounting substrate 42, and a sirocco fan was used as the fan 5. As illustrated in FIG. 4, in Example D, the acetaldehyde concentration decreased during irradiation of ultraviolet rays as compared to Example C. From this, it is understood that the acetaldehyde removal performance was improved further since the housing 41 of the light emitting device 4 is not provided (the power supply substrate 44 is exposed).

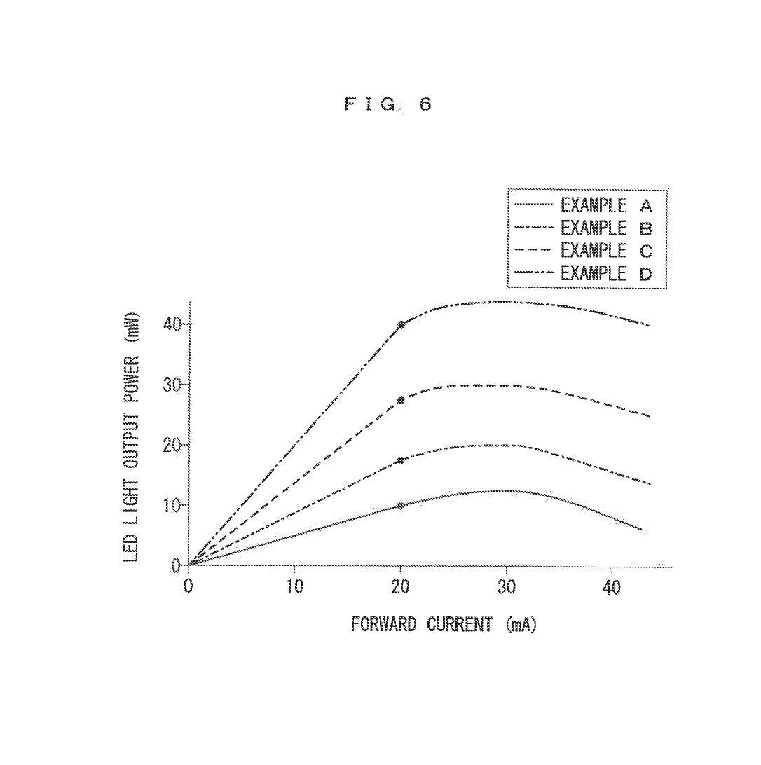

FIG. 6 is a graph illustrating an operation performance of LED elements, in which a horizontal axis indicates a forward current (mA) and a vertical axis indicates LED light output power (mW).

As illustrated in FIG. 6, it is understood that the light output power of the LED element 43 was improved in the order of Example A, Example B, Example C, and Example D. This results from the improvement in heat radiation of LEDs. That is, the light output power of the LED elements 43 is improved when a copper-based substrate is used as the mounting substrate 42 of the light emitting device 4 as compared to an aluminum-based substrate. Moreover, the light output power of the LED elements 43 is improved when a sirocco fan is used as the fan 5 of the compact air purification apparatus 1 as compared to a propeller fan. Furthermore, the light output power of the LED elements 43 is improved when the housing 41 of the light emitting device 4 is not provided as compared to when the same is provided.

In the embodiment, although an example in which the LED elements 43 having the peak wavelength of 405 nm are used has been illustrated, the peak wavelength is not limited to this, but may be 365 nm, for example.

In the embodiment, although an example in which the ceramic foam 3 coated with titanium oxide particles is used has been illustrated, a plastic material such as polyester and liquid such as water can be also used instead of the ceramic foam 3 as long as the material contains titanium oxides.

Although the embodiment and examples of the invention have been described above, the invention according to claims is not to be limited to the above-mentioned embodiment and examples. Moreover, all combinations of the features described in the embodiment and examples are not necessary to solve the problem of the invention.

### INDUSTRIAL APPLICABILITY

As described above, the compact air purification apparatus of the present invention is industrially useful since the apparatus can improve the acetaldehyde removal performance and can be reduced in size.

### REFERENCE SIGNS LIST

1: Compact air purification apparatus
2: Housing
3: Ceramic foam
4: Light emitting device
5: Fan
42: Mounting substrate
43: LED element

1. A compact air purification apparatus, comprising:
a housing;
a photocatalyst member that is disposed in the housing and contains titanium oxides;
a light emitting unit that is disposed in the housing to irradiate the photocatalyst member with ultraviolet light and includes a plurality of LED elements; and
a fan that circulates air inside the housing.

2. The compact air purification apparatus according to claim 1, wherein the light emitting unit has a copper-based substrate on which the LED elements are mounted.

3. The compact air purification apparatus according to claim 1, wherein the fan is a sirocco fan.

4. The compact air purification apparatus according to claim 3, wherein a power supply unit of the light emitting unit is exposed in the housing.

5. The compact air purification apparatus according to claim 1, wherein the light emitting unit is a halogen lamp-shaped light emitting device.

6. The compact air purification apparatus according to claim 1, wherein the light emitting unit has a highly integrated structure of the LED elements which are mounted on a mounting substrate with predetermined mounting intervals.

7. The compact air purification apparatus according to claim 6, wherein the LED elements mounted on the mounting substrate is 50 or more.

8. The compact air purification apparatus according to claim 6, wherein the LED elements are mounted on a mounting substrate with mounting intervals of 20 μm to 200 μm.

9. The compact air purification apparatus according to claim 1, wherein a light output power of the light emitting unit is 600 mW or higher.

10. The compact air purification apparatus according to claim 1, wherein a peak wavelength of the LED elements is 400 nm or longer and 410 nm or shorter.

11. The compact air purification apparatus according to claim 1, wherein a peak wavelength of the LED elements is 405 nm.

12. The compact air purification apparatus according to claim 1, wherein the photocatalyst member comprises a plastic material coated with titanium oxide particles.

13. The compact air purification apparatus according to claim 12, wherein the plastic material contains polyester.

14. The compact air purification apparatus according to claim 12, wherein the plastic material has a three-dimensional structure.
